(19) United States
(12) Patent Application Publication
(10) Pub. No.: US 2005/0143507 A1
(43) Pub. Date: Jun. 30, 2005

(54) Process for the production of polymeric sulfur

(76) Inventors: Jorg Hagemann, Koln (DE); Christoph Zurlo, Berlin (DE)

Correspondence Address: LANXESS CORPORATION, 111 RIDC PARK WEST DRIVE, PITTSBURGH, PA, 15275-1112, US

(21) Appl. No.: 10/894,696

(22) Filed: Jul. 20, 2004

(30) Foreign Application Priority Data
Jul. 23, 2003 (DE) 10333374.6

(51) Int. Cl. C08K 3/30

(52) U.S. Cl. 524/418

(57) ABSTRACT

The present invention relates to a process for the production of polymeric sulfur, including a) distilling a mixture of liquid sulfur and a solvent for cycloocta sulfur with a boiling point of less than 444° C. at standard pressure, wherein the bottoms temperature is lower than the boiling temperature of the sulfur and greater than the boiling temperature of the solvent and is at least 120° C.; b) quenching of the sulfur melt obtained as the bottoms product of the distillation according to a) with a non-basic liquid or a mixture of non-basic liquids to a temperature below the melting temperature of sulfur.

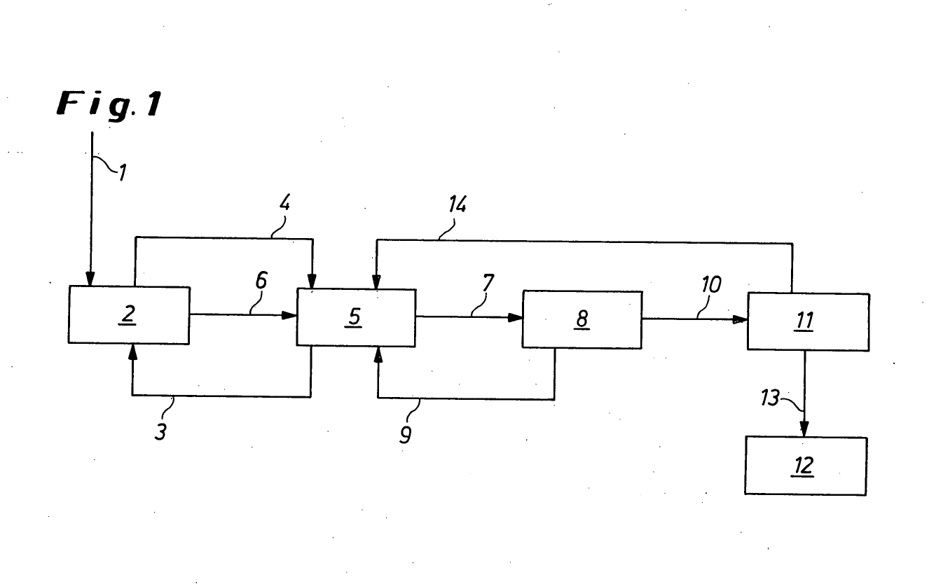

### FIELD OF THE INVENTION

The present invention relates to a process for the production of polymeric sulfur.

### BACKGROUND OF THE INVENTION

Polymeric sulfur is also known as amorphous sulfur, insoluble sulfur (since it is insoluble in carbon disulfide), catena sulfur or μ sulfur. This modification of sulfur consists of chains of up to several thousand sulfur atoms. It is metastable, i.e. it changes over time at a variable rate, for example as a function of temperature, into a stable, non-polymeric form (reversion). The modification of sulfur which is stable under standard conditions is known as cycloocta sulfur, α-sulfur, soluble sulfur (since it is soluble in carbon disulfide) or rhombic sulfur.

Polymeric sulfur is mainly used as a vulcanizing agent in the rubber-processing industry.

Processes for the production of polymeric sulfur starting from sulfur have long been known. U.S. Pat. No. 2,419,310 and GB 64 69 16, for example, disclose processes in which sulfur vapor is quenched in carbon disulfide and counter currently extracted. The insoluble sulfur obtained as a solid after extraction is separated and dried. The mother liquor, a solution of soluble sulfur in carbon disulfide is worked up by distillation, wherein the sulfur melt located in the bottoms is stripped with steam in order to remove the carbon disulfide completely. The disadvantages of these processes according to U.S. Pat. No. 2,419,310 and GB 64 69.16 are the reactor fouling caused by deposits of insoluble sulfur and the waste water treatment which is required because, due to its toxicological properties, carbon disulfide must not be released into the environment. Furthermore, according to GB 72 72 06, in order to achieve elevated conversion rates of above 60% in these processes, the steam must be superheated to 650-700° C. This results in corrosion problems in the sulfur vaporizer and the feed lines to the quenching apparatus.

Another possible way of producing polymeric sulfur directly from sulfur consists in quenching a sulfur melt, which is preferably above 300° C., to below 60° C. The quenching medium used in this case is water (c.f. for example U.S. Pat. Nos. 1,875,372, 2,460,365, and 4,234,552), but cooling with air is also known. Finally, the solidified and optionally ground melt is preferably extracted with carbon disulfide. The polymeric sulfur must then be separated and dried in accordance with known methods and the mother liquor worked up. Disadvantages of these processes include the change of solvent which is required, entailing intermediate drying, together with the time required after water quenching for the sulfur, which remains plastic immediately after quenching with water, to crystallize (2-3 days at room temperature).

All the described processes additionally have the disadvantage that the cycloocta sulfur which can be recovered from the extracting agent must be subjected to an additional process step, such as for example the steam stripping described in GB 64 69 16, in order to remove any residues of carbon disulfide, before the sulfur can be recirculated.

Accordingly the present invention provides a process for the production of polymeric sulfur in which the stated disadvantages are avoided. The energy consumption of the process should be minimized to a considerable extent.

### SUMMARY OF THE INVENTION

The present invention provides a process for the production of polymeric sulfur including
a) distilling a mixture of liquid sulfur and a solvent for cycloocta sulfur with a boiling point of less than 444° C. at standard pressure, wherein the bottoms temperature is lower than the boiling temperature of the sulfur and greater than the boiling temperature of the solvent and is at least 120° C.
b) quenching of the sulfur melt obtained as the bottoms product of the distillation according to a) with a non-basic liquid or a mixture of non-basic liquids to a temperature below the melting temperature of sulfur.

### BRIEF DESCPRITON OF THE DRAWINGS

The FIGURE is a diagram of a process according to the present invention.

### DETAILED DESCRIPTION OF THE INVENTION

The starting product for the process according to the present invention is liquid sulfur. Preferably having a purity of at least 99 wt. %, more preferably of at least 99.7 wt. %.

The solvent for cycloocta sulfur having a boiling point of less than 444° C. at standard pressure and, at 20° C., dissolves at least 1 g/l, preferably at least 10 g/l and more preferably at least 100 g/l. Carbon disulfide, tetrachloroethylene, toluene and n-hexane may, for example, be considered, carbon disulfide being preferred.

In the distillation according to the present invention of step a), the bottoms temperature is less than the boiling temperature of the sulfur and greater than the boiling temperature of the solvent at the selected pressure, but is at least 120° C. Irrespective of the selected pressure, the bottoms temperature is preferably at least 250° C., in more preferably at least 300° C. and most preferably at least 350° C.

Distillation may be performed under reduced pressure, standard pressure or elevated pressure, elevated pressure being preferred. Elevated pressure preferably ranges from 0.1 to 100 bar absolute, more preferably from 1 to 30 bar absolute and most preferably from 3 to 15 bar absolute. The bottoms temperature and the pressure are selected such that the bottoms temperature is above the boiling point of the solvent for cycloocta sulfur and below the boiling point of sulfur, but is at least 120° C.

Distillation may be performed as a single-stage or multistage process. Two-stage distillation is preferred. In this case, the solvent is removed by distillation in the first stage down to a residual content of for example 5 wt. % and, in a second stage, the solvent is removed from the bottoms down to the lowest possible residual content at the given temperature and pressure. Distillation apparatus which may be used includes, for example, a simple pot still, a kettle reboiler, a falling-film evaporator or coiled tube evaporator. Preferably, a kettle reboiler with a column fitted on top is used. More preferably, a combination of a distillation column with a still pot and a downstream coiled tube evaporator is used. Columns which may be used are, for example, packed columns, slotted tray columns or bubble-tray columns. The column may also take the form of a divided-wall column, it being straightforwardly possible to accumulate and discharge any medium-boiling impurities.

Quenching of the sulfur melt, which is obtained as the bottoms product in step a) of the process according to the present invention, proceeds by bringing the melt into contact with a non-basic liquid. To this end, the melt may be introduced either directly into the non-basic liquid or into the quenching vessel above the liquid surface. In the latter case, the melt then drips or flows into the liquid.

Alternatively, the melt may be brought into contact with the liquid in a two-fluid nozzle.

Quenching should proceed sufficiently fast for severe reversion to be avoided. To this end, the melt is in particular broken up into small drops of a diameter of 0.01 to 5 mm, preferably of 0.01 to 0.15 mm or of 0.5 to 3.0 mm. Smaller drops have the advantage that they may be extracted more effectively than larger drops. Moreover, provided that they are smaller than 0.15 mm, smaller drops need not subsequently be ground. However, smaller drops have the disadvantage relative to larger drops that they are more difficult to separate from the non-basic liquid.

Above the liquid surface, drop formation may proceed, for example, by dripping, Rayleigh breakup, wavy sheet disintegration, spraying, atomization or prilling, and below the liquid surface, by atomization or in a jet tube. Preferably, the sulfur melt is introduced above the liquid surface. More preferably, the sulfur melt is forced into the quenching vessel through one or more perforated diaphragms. The diameters of the perforated diaphragms are here designed such that, at a given sulfur stream, the jet breaks up by Rayleigh breakup.

Non-basic liquids include liquids which have a pKx value of less than or equal to 14, i.e. which, in the case of an aqueous solution, give rise to a pH value of less than or equal to 7. Such liquids may be, for example, water (optionally with additions such as hydrogen peroxide, per-acids, gelatin, size, sulfur dioxide, sulfonates, sulfinates, alkali metal or alkaline earth chlorides or mineral acids), chlorinated hydrocarbons according to U.S. Pat. No. 2,667,406, such as for example, tetrachloromethane and tetrachloroethylene, aromatic or aliphatic hydrocarbons, such as for example toluene and hexane, and carbon disulfide, with carbon disulfide being preferred.

The temperature of the liquid is below 120° C., preferably below 80° C. and more preferably below 60° C. Boiling carbon disulfide is preferable.

Once the sulfur melt has been quenched according to step b) of the process according to the present invention, extraction is performed and, in the event that the extracting agent still contains a certain quantity of cycloocta sulfur after the extraction, the polymeric sulfur is washed with a solvent for cycloocta sulfur. Washing is preferably performed if, after a possible separation of the polymeric sulfur, the residual extracting agent remaining therein would contain more than 1 wt. % of cycloocta sulfur relative to the polymeric sulfur. Extraction and washing may in each case be performed concurrently or counter currently, counter current operation being preferred. Extraction may be performed continuously in a multiple-effect pot extraction unit or an extractor or batchwise in a stirred-tank reactor or an extractor. Examples of extractors which may be used are diffusers, vertical extractors with stirrer, rotary extractors, extraction filter presses, rotary disk or agitated extraction towers, bucket elevator, screw, cell or carousel cell extractors.

Washing may, for example, be performed by washing the suspension obtained in the extraction step by continuous or batchwise solvent exchange in an extractor or stirred-tank reactor or a cascade of extractors or stirred-tank reactors, the solvent preferably being passed counter currently in the case of a cascade. Another possible method of washing consists in separating the extracted polymeric sulfur and then washing it as a filter cake or optionally repeatedly resuspending and reseparating it.

Preferably, the extraction and washing proceed in a countercurrent extractor which is operated such that the extracting agent contains virtually no soluble sulfur at the outlet of the suspension. One countercurrent extractor which may, for example, be used is an agitated extraction tower using the mixer-settler principle. Carbon disulfide is preferably used as the extraction and washing solvent for cycloocta sulfur.

More preferably, the quenching and extraction proceed in a countercurrent extractor into which the sulfur melt is introduced from the top. Quenching in the countercurrent extractor proceeds as described above: the melt may be introduced either directly into the non-basic liquid or above the liquid surface in the countercurrent extractor. The melt may also be brought into contact with the non-basic liquid in a two-fluid nozzle. The melt is, for example, broken up into drops. Above the liquid surface, drop formation may proceed, for example, by dripping, Rayleigh breakup, wavy sheet disintegration, spraying, atomization or prilling, and below the liquid surface, by atomization or in a jet tube.

Separation of the polymeric sulfur may be performed both batchwise and continuously. This operation may be performed, for example, using filters (for example Nutsch filters, filter presses, filter dryers, drum, rotary or belt filters), screens (for example curved, drum or gyratory screens) or centrifuges (for example skimmer, tubular, helical-conveyor, disk, link-suspended, screen, screen-conveyor or pusher centrifuges). In the case of particles smaller than 0.15 mm, continuously operated helical-conveyor or screen-conveyor centrifuges are preferably used, with screens preferably being used for particles larger than 0.5 mm.

Preferably, after extraction the extracting agent, i.e. the solvent laden with cycloocta sulfur, is introduced into the distillation according to step a). A quantity of sulfur corresponding to the separated quantity of polymeric sulfur is moreover preferably introduced into the distillation.

The solvent-moist polymeric sulfur is dried batchwise or continuously at standard pressure or under a vacuum. Examples of suitable dryers are belt, drum, paddle, asymmetrically moved, multitier, disk or air-lift dryers. Drying is preferably performed under a vacuum and particularly preferably continuously under a vacuum, in the case of particles smaller than 0.15 mm in a paddle dryer with wall-scraping paddles.

Preferably, the polymeric sulfur is subjected to a comminution step, if the particle size of the sulfur particles (primary particles or aggregates or agglomerates of the primary particles) produced in the quenching process exceeds 500 μm, preferably 300 μm, more preferably 150 μm. Comminution may be performed on the particles in suspension in the solvent, on the solvent-moist particles or on the dry particles. Comminution may be performed, for example, using wet mills (homogenizers), drum, vibratory, jet, impact, hammer, toothed-disk or fluidized bed jet mills, the mills preferably being equipped with a classifying device (for example screens or pneumatic classifiers). During grinding, in order to avoid reversion, the material being ground should not exceed a temperature of 70° C., preferably 60° C., more preferably 50° C. To this end, the mill or optionally used circulating gas may be cooled.

Preferably, the comminution step proceeds after extraction/washing and before the mechanical separation using a wet mill (homogenizer) or after drying using an impact or fluidized jet mill with cooled circulating gas.

The polymeric sulfur can be used in the rubber processing industry in both pure and oiled form. The polymeric sulfur may be oiled in known manner in mixing units, such as for example a planetary mixer, paddle kneader, rotary, asymmetrically moved, screw or Nauta mixers. Continuously operated mixing units are preferred. Oils which are used comprise paraffinic, naphthenic or aromatic oils, with paraffinic and naphthenic oils being preferred.

Individual process steps for isolating (mechanical separation and drying) and finishing (comminution and oiling) may optionally be combined and performed in succession or simultaneously in one apparatus. Examples of such combinations are provided by filter dryers, with which the insoluble sulfur may be separated and dried, and mixer dryers, with which the separated sulfur may be mixed with oil and dried.

In order to reduce reversion, i.e. in order to improve stability in storage, the polymeric sulfur is preferably combined with stabilizers. The stabilizer or stabilizers may be added to the suspension, to the solvent-moist product or to the dry product. In the case of addition to the solvent-moist or dry product, the above-mentioned mixing units may be used. Stabilizers which may, for example, be used include unsaturated hydrocarbons (for example α-methylstyrene, myricin, α-pinene) or halogen compounds (for example thionyl chloride, disulfur dichloride, thionyl bromide, iodine), with α-methylstyrene being preferred. A stabilizer is preferably used in an amount of 0.02-2 wt. % and more preferably of 0.1-1 wt. %.

The advantages of the process according to the present invention reside in the fact that the extracting agent is not completely removed from the cycloocta sulfur recovered from the extracting agent and, due to the quenching of a sulfur melt, corrosion problems and reactor fouling is reduced. Furthermore, due to the preferred use of carbon disulfide for quenching and extraction, a complicated change of solvent is avoided.

The invention is illustrated in greater detail below with reference to the attached drawings. The FIGURE shows a diagram of the process according to the invention, which is described in greater detail in Example 1.

### EXAMPLES

### Example 1

A stream 1 of 170 kg/h of liquid sulfur with a temperature of 140° C. and 1500 kg/h of a 21 wt. % solution 3 of sulfar in carbon disulfide were introduced into a two-stage distillation unit 2, which consisted of a bubble-tray column and a falling film evaporator and was operated at 7.5 bar absolute. 1175 kg/h of pure carbon disulfide 4 were obtained as overhead product, which was pumped into the extraction section of a vessel 5, which served as a quenching/extraction unit. 495 kg/h of sulfur melt 6 with a temperature of 380° C. were taken from the bottom of the distillation unit 2 and transferred into the vessel 5 serving as a quenching/extraction unit. For the purpose of quenching the sulfur melt, the quenching/extraction unit 5 was partially filled with carbon disulfide as the non-basic liquid. The sulfur melt 6 was introduced into the upper part of the quenching/extraction vessel 5 through a perforated plate with 100 holes 2.5 mm in diameter. The distance from the underside of the perforated plate to the surface of the liquid (carbon disulfide) was 1.25 m. The particles obtained after solidification of the sulfur drops sank in the counter currently operated extraction section (agitated extraction tower with 20 sections) of the vessel 5.950 kg/h of a suspension 7 of polymeric sulfur in carbon disulfide were withdrawn at a temperature of 40° C. from the outlet of the extraction section of the vessel 5 and transferred into a decanter 8.605 kg/h of the carbon disulfide 9 separated in the decanter 8 were pumped into the extraction section of the quenching/extraction vessel 5.345 kg/h of the moist polymeric sulfur 10 with a temperature of 40° C. were transferred into a vacuum disk dryer 11 and dried at 60 mbar and 40° C. 175 kg/h of carbon disulfide 14 were returned to the quenching/extraction vessel 5. In this manner, 170 kg/h of polymeric sulfur 13 were obtained which was finally subjected to finishing (grinding, stabilization, oiling and packaging) 12, i.e. the polymeric sulfur 13 was, in known manner, ground, mixed with naphthenic mineral oil and α-methylstyrene and finally packaged.

### EXAMPLE 2

A sulfur melt at 400° C. was pumped in a quantity of 1 l/h through a 0.7 mm diameter perforated diaphragm into the top of a stirred vessel filled with carbon disulfide. The distance between the perforated diaphragm and liquid surface was 50 cm. The resultant suspension was separated by means of a pressure Nutsch filter.

Flat, oval pastilles of a diameter of 0.5-4 mm were obtained.

The described test was repeated with various diaphragm diameters, sulfur flow rates and sulfur temperatures. The following Table summarizes the tests.

| | Diaphragm | Sulfur flow | |
|---|---|---|---|
| Example | diameter [mm] | rate [l/h] | Temperature [° C.] |
| 2-1 | 0.7 | 1 | 400 |
| 2-2 | 0.7 | 2 | 350 |
| 2-3 | 0.7 | 4 | 400 |
| 2-4 | 1.0 | 1 | 420 |
| 2-5 | 1.0 | 2 | 380 |
| 2-6 | 1.0 | 4 | 400 |
| 2-7 | 2.0 | 2 | 380 |
| 2-8 | 2.0 | 4 | 400 |
| 2-9 | 3.0 | 1 | 320 |
| 2-10 | 3.0 | 3 | 380 |
| 2-11 | 3.0 | 6 | 420 |
| 2-12 | 4.0 | 1 | 360 |
| 2-13 | 4.0 | 4 | 400 |

In all cases, flat, oval pastilles with a diameter of 0.5-4 mm and a comparable size distribution were obtained.

The Example demonstrates that Rayleigh breakup is suitable for producing particles from a sulfur melt and moreover permits a very large load range.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of polymeric sulfur, comprising:
a) distilling a mixture of liquid sulfur and a solvent for cycloocta sulfur with a boiling point of less than 444° C. at standard pressure, wherein bottoms temperature is lower than the boiling temperature of the sulfur and greater than the boiling temperature of the solvent and is at least 120° C.
b) quenching of the sulfur melt obtained as the bottoms product of the distillation according to a) with a non-basic liquid or a mixture of non-basic liquids to a temperature below the melting temperature of sulfur.

2. A process according to claim 1, wherein the solvent is carbon disulfide.

3. A process according to claim 1, wherein the non basic liquid is carbon disulfide.

4. A process according to claim 1, wherein the distillation according to a) is performed at a pressure of 0.1 to 100 bar absolute.

5. A process according to claim 4, wherein the distillation according to a) is performed a pressure of 1 to 30 bar absolute.

6. A process according to claim 5, wherein the distillation according to a) is performed a pressure of 3 to 15 bar absolute.

7. A process according to claim 1, wherein the distillation according to a) proceeds at a bottoms temperature of at least 250° C.

8. A process according to claim 7, wherein the distillation according to a) proceeds at a bottoms temperature of at least 300° C.

9. A process according to claim 8, wherein the distillation according to a) proceeds at a bottoms temperature of at least 350° C.

10. A process according to claim 1 wherein prior to quenching the sulfur melt with a non-basic liquid according to b), the sulfur melt is broken up into drops of 0.01 to 5 mm in diameter.

11. A process according to claim 1, wherein, after the quenching according to b), c) the sulfur is extracted with a solvent for cycloocta sulfur, preferably with carbon disulfide.

12. A process according to claim 11, wherein after the extraction according to c), the solvent laden with cycloocta sulfur is reintroduced into the distillation according to a).

13. A process according to claim 1, wherein the polymeric sulfur is combined with at least one stabilizer.

14. A process according to claim 13, wherein the stabilizer is an unsaturated hydrocarbon or a halogen compound.

15. A process according to claim 14, wherein the stabilizer is α-methylstyrene, thionyl chloride or disulfur dichloride.

16. A process according to claim 1, wherein the polymeric sulfur is combined with at least one oil.

17. A process according to claim 16, wherein the oil is a paraffinic or naphthenic mineral oil.

18. A rubber compound comprising polymeric sulfur produced according to the process of claim 1.
